(19) United States
(12) Patent Application Publication
(10) Pub. No.: US 2021/0172071 A1
(43) Pub. Date: Jun. 10, 2021

(54) HARD AND WEAR RESISTANT TITANIUM ALLOY AND PREPARATION METHOD THEREOF

(71) Applicants: Monireh Ganjali, Tehran (IR); Pouya Karimyan, Tehran (IR)

(72) Inventors: Monireh Ganjali, Tehran (IR); Pouya Karimyan, Tehran (IR)

(21) Appl. No.: 16/703,960

(22) Filed: Dec. 5, 2019

(51) Int. Cl. C23D 5/02; B32B 15/04; C22C 14/00; C03C 10/00

(52) U.S. Cl. CPC C23D 5/02; B32B 15/04; C03C 2204/00; C03C 10/0018; C03C 10/0054; C22C 14/00

(57) ABSTRACT

The present invention discloses a hard and wear resistant titanium alloy and a method of preparing the hard and wear resistant titanium alloy utilizing laser cladding method. A glass-ceramic composite of SiO₂—Al₂O₃—ZrO₂—Y₂O₃—K₂O—Na₂O—B₂O₃ is coated on titanium alloy Ti-6Al-4V substrate utilizing laser cladding. The laser cladding method replaces the need of industrial furnaces and reduces the amount of pollutants entering the atmosphere. The titanium Ti-6Al-4V alloy coated with the glass ceramic composite could be used in the aviation and maritime industries, instead of nickel and cobalt-based superalloys, to significantly reduce costs.

### BACKGROUND OF THE INVENTION

Titanium and its alloys, in particular Ti-6Al-4V alloys, are used in aerospace, marine, and chemical industries due to their excellent mechanical properties, high specific strength to weight ratio, and good corrosion resistance. Owing to properties such as low density and non-toxicity, Ti-6Al-4V alloys are also used in biomedical implants. Nevertheless, poor biological properties, high-temperature oxygen sensitivity and contact corrosion in industrial applications, as well as bone adhesion deficiency with inflammatory reactions next to the metal surface in biomedical implants, have restricted the potential of the Ti-6Al-4V alloy. Hence, effective oxidation protection of titanium alloy is need to be solved. Further, in the metal-forming process at high temperatures, friction plays a significant role in the quality of the finished product, the life of tools, and formability of materials. Thus, studying the friction and wear resistance of Ti-6Al-4V titanium alloy is necessary and has been improved by different surface engineering techniques such as coating.

Despite the advancements in the art, there is still a need for a hard and wear resistant titanium alloy and a method of preparing the hard and wear resistant titanium alloy that could be used in the aviation and maritime industries while replacing the need of industrial furnaces, reduces the amount of pollutants entering the atmosphere, or replaces the need for a bond coat or slipware. Further, there is a need for a method of coating titanium alloy without requiring any specific technical knowledge and reduces the cost involved in coating and maintenance.

### SUMMARY OF THE INVENTION

The present invention discloses a hard and wear resistant titanium alloy and a method of preparing the hard and wear resistant titanium alloy utilizing a laser cladding method.

The hard and wear resistant alloy of the present invention comprises a Ti-6Al-4V substrate coated by a glass-ceramic composite of SiO₂—Al₂O₃—ZrO₂—Y₂O₃—K₂O—Na₂O—B₂O₃. The glass-ceramic composite is coated to the Ti-6Al-4V substrate by a laser cladding method. The composite comprises silicon dioxide (SiO₂) of 51 mole %, yttrium (III) oxide (Y₂O₃) of 2.4 mole %, potassium carbonate (K₂CO₃) of 4 mole %, sodium carbonate (Na₂CO₃) of 6 mole %, zirconium dioxide (ZrO₂) of 5.6 mole %, boric acid (H₃BO₃) of 20 mole %, and aluminum oxide (Al₂O₃) of 11 mole %. The Ti-6Al-4V substrate comprises aluminum (Al) of 5.83 wt %, vanadium (V) is 3.86 wt %, copper (Cu) of 0.15 wt %, molybdenum (Mo) of 0.43 wt %, stannum (Sn) of 0.35 wt %, niobium (Nb) of 0.35 wt %, palladium (Pd) of 0.15 wt %, iron (Fe) of 0.15 wt %, and titanium (Ti) of 90 wt %.

In one embodiment, the method of preparing hard and wear resistant titanium alloy is disclosed. At one step, a Ti-6Al-4V substrate is prepared. Initially, one or more Ti-6Al-4V plates with dimensions of 30×10×1 mm are grounded with silicon carbide papers of 400-2000 grit and polished with a 5m diamond paste. The polished mixture is then treated by sandblast method followed by ultrasonic cleaning and drying to form the Ti-6Al-4V substrate.

At another step, a glass-ceramic slurry of SiO₂—Al₂O₃—ZrO₂—Y₂O₃—K₂O—Na₂O—B₂O₃ is prepared. Raw glass materials including silicon dioxide (SiO₂), yttrium (III) oxide (Y₂O₃), potassium carbonate (K₂CO₃), sodium carbonate (Na₂CO₃), zirconium dioxide (ZrO₂), boric acid (H₃BO₃), and aluminum oxide (Al₂O₃) are mixed. Thereafter, at least one of ethanol or water is mixed with the mixture in 2:1 ratio. Further, 1.5 g of 1% CMC adhesive is added to the mixture and grounded to form the glass-ceramic slurry. At yet another step, the slurry is sprayed onto the Ti-6Al-4V substrate. At yet another step, the slurry on the Ti-6Al-4V substrate is dried. At yet another step, a continuous wave of CO₂ laser is applied on the slurry for cladding to form the hard and wear resistant titanium alloy. The CO₂ laser comprises an operating wavelength of 10.6 nm, a laser beam diameter of 2 mm, and an output power of 70-100 W with scanning speed 1-3 mm/s.

One aspect of the present disclosure is directed to a method of preparing hard and wear resistant titanium alloy, comprising the steps of: preparing a Ti-6Al-4V substrate; preparing a glass-ceramic slurry of SiO₂—Al₂O₃—ZrO₂—Y₂O₃—K₂O—Na₂O—B₂O₃; spraying the slurry onto the Ti-6Al-4V substrate; drying the slurry on the Ti-6Al-4V substrate; and applying a continuous wave of CO₂ laser to form the titanium alloy. In one embodiment, the step of preparing Ti-6Al-4V substrate includes: (a) providing one or more Ti-6Al-4V plates with dimensions of 30×10×1 mm; grounding the plates with silicon carbide papers of 400-2000 grit; polishing a mixture obtained at step (b) with 5m diamond paste; treating a mixture obtained at step (c) using a sandblast method; and cleaning and drying a mixture obtained at step (d) to form the Ti-6Al-4V substrate.

In another embodiment, the step of preparing the glass-ceramic slurry of SiO₂—Al₂O₃—ZrO₂—Y₂O₃—K₂O—Na₂O—B₂O₃ includes: (a) mixing raw glass materials including silicon dioxide (SiO₂), yttrium (III) oxide (Y₂O₃), potassium carbonate (K₂CO₃), sodium carbonate (Na₂CO₃), zirconium dioxide (ZrO₂), boric acid (H₃BO₃), and aluminum oxide (Al₂O₃); (b) mixing at least one of ethanol or water with the mixture obtained at step (a) in 2:1 ratio; and (c) adding 1.5 g of 1% CMC adhesive to a mixture obtained at step (b) and grounded to form the glass-ceramic slurry. In one embodiment, the CO₂ laser comprises an operating wavelength of 10.6 nm, a laser beam diameter of 2 mm, and an output power of 70-100 W with scanning speed 1-3 mm/s. In another embodiment, the glass-ceramic slurry comprises silicon dioxide (SiO₂) of 51 mole %, yttrium (III) oxide (Y₂O₃) of 2.4 mole %, potassium carbonate (K₂CO₃) of 4 mole %, sodium carbonate (Na₂CO₃) of 6 mole %, zirconium dioxide (ZrO₂) of 5.6 mole %, boric acid (H₃BO₃) of 20 mole %, and aluminum oxide (Al₂O₃) of 11 mole %. In yet another embodiment, the Ti-6Al-4V substrate comprises aluminum (Al) of 5.83 wt %, vanadium (V) is 3.86 wt %, copper (Cu) of 0.15 wt %, molybdenum (Mo) of 0.43 wt %, stannum (Sn) of 0.35 wt %, niobium (Nb) of 0.35 wt %, palladium (Pd) of 0.15 wt %, iron (Fe) of 0.15 wt %, and titanium (Ti) of 90 wt %.

Another aspect of the present disclosure is directed to a hard and wear resistant titanium alloy, comprising: a Ti-6Al-4V substrate coated by a glass-ceramic composite of SiO₂—Al₂O₃—ZrO₂—Y₂O₃—K₂O—Na₂O—B₂O_{3,} wherein the composite comprises silicon dioxide (SiO₂) of 51 mole %, yttrium (III) oxide (Y₂O₃) of 2.4 mole %, potassium carbonate (K₂CO₃) of 4 mole %, sodium carbonate (Na₂CO₃) of 6 mole %, zirconium dioxide (ZrO₂) of 5.6 mole %, boric acid (H₃BO₃) of 20 mole %, and aluminum oxide (Al₂O₃) of 11 mole %, and wherein the substrate comprises aluminum (Al) of 5.83 wt %, vanadium (V) is 3.86 wt %, copper (Cu) of 0.15 wt %, molybdenum (Mo) of 0.43 wt %, stannum (Sn) of 0.35 wt %, niobium (Nb) of 0.35 wt %, palladium (Pd) of 0.15 wt %, iron (Fe) of 0.15 wt %, and titanium (Ti) of 90 wt %. In one embodiment, the glass-ceramic composite is coated to the Ti-6Al-4V substrate by laser cladding method. In another embodiment, the glass-ceramic composite is coated to the Ti-6Al-4V substrate by applying a continuous wave of CO₂ laser. In one embodiment, the CO₂ laser comprises an operating wavelength of 10.6 nm, a laser beam diameter of 2 mm, and an output power of 70-100 W with scanning speed 1-3 mm/s.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1 exemplarily illustrates a flowchart of a preparation method of hard and wear resistant titanium alloy, according to an embodiment of the present invention;

FIG. 2 exemplarily illustrates a graph of X-ray diffraction (XRD) patterns of laser treated samples, according to an embodiment of the present invention; the XRD of laser coated samples are shows in FIG. 2 a) before and b) after heat treatment;

FIG. 3 exemplarily illustrates a graph of X-ray diffraction analysis spectra for laser treated samples (a) before and (b) after heat treatment, according to an embodiment of the present invention;

FIG. 4A exemplarily illustrates an image of scanning electron microscope (SEM) cross-section of laser coated sample before heat treatment, according to an embodiment of the present invention;

FIG. 4B exemplarily illustrates an image of scanning electron microscope (SEM) cross-section of laser coated sample after heat treatment, according to an embodiment of the present invention;

FIG. 4C exemplarily illustrates an image of scanning electron microscope (SEM) cross-section of laser coated samples after heat treatment at different magnification, according to an embodiment of the present invention;

FIG. 5 exemplarily illustrates images of MAP analysis of the cross-sectional area of the heat-treated sample, according to an embodiment of the present invention;

### DETAILED DESCRIPTION

The present invention generally relates to titanium alloy and preparation method thereof. More particularly, the present invention relates to a hard and wear resistant titanium alloy and a method of preparing the hard and wear resistant titanium alloy utilizing laser cladding method.

A description of embodiments of the present invention will now be given with reference to the figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention discloses a hard and wear resistant titanium alloy and a method of preparing the titanium alloy. The titanium alloy comprises a titanium substrate coated by a glass-ceramic composite. Particularly, the titanium alloy comprises a Ti-6Al-4V substrate coated with SiO₂—Al₂O₃—ZrO₂—Y₂O₃—K₂O—Na₂O—B₂O₃ glass-Ceramic composite.

In one embodiment, the method of preparation of the Ti-6Al-4V substrate is disclosed. One or more Ti-6Al-4V plates are used as substrates. In one embodiment, the titanium sheet is 30×10×1 mm in dimension. The chemical composition of the Ti-6Al-4V substrates was determined by optical emission spectrometry. The chemical composition of the Ti-6Al-4V is shown in Table 1. The substrates are ground with successive SiC papers of 400-2000 grit and polished with 5m diamond paste. The substrates are then treated by sandblast method followed by ultrasonic cleaning and then drying.

TABLE 1
Chemical composition (wt-%) of Ti—6Al—4V

| Elements | Al | V | Cu | Mo | Sn | Nb | Pd | Fe | Ti |
|---|---|---|---|---|---|---|---|---|---|
| Atomic % | 5.83 | 3.86 | 0.15 | 0.43 | 0.35 | 0.35 | 0.15 | 0.15 | Balance |

In one embodiment, the method of preparation of glass ceramic composite is disclosed. A mixture of raw glass materials with molar percentages presented in Table 2, was prepared and mixed with ethanol or water in a 2:1 ratio. The raw glass materials have purity of 99% or higher than 99%. The raw glass materials include SiO₂, Y₂O₃, K₂CO₃, Na₂CO₃, ZrO₂, H₃BO₃, and Al₂O₃.

TABLE 2
The molar percentage of compounds used in
the preparation of glass ceramic composite

| Compound | SiO₂ | Y₂O₃ | K₂CO₃ | Na₂CO₃ | ZrO₂ | H₃BO₃ | Al₂O₃ |
|---|---|---|---|---|---|---|---|
| Mole % | 51 | 2.4 | 4 | 6 | 5.6 | 20 | 11 |

Thereafter, 1.5 g of 1% CMC adhesive is added to the mixture and ball milled inside a planetary mill and ground for 1 hour. The grounding of mixture results in uniform slurry with perfectly fine powder particles. The prepared slurry is sprayed onto the sandblasted titanium substrates by the pistol. After drying the slurry on the substrate, the continues wave (CW) CO₂ laser with an output power of 70-100 W and scanning speed 1-3 mm/s are used for cladding, disclosed in Table 3. The continuous wave CO₂ laser has a wavelength of 10.6 nm and 2 nm diameter of laser beam.

TABLE 3
Laser-treated samples

| | power | Scan speed |
|---|---|---|
| Sample codes | (W) | (mm/s) |
| LP-70-1 | 70 | 1 |
| LP-80-1 | 80 | 1 |
| LP-90-1 | 90 | 1 |
| LP-95-1 | 95 | 1 |
| LP-95-3 | 95 | 3 |
| LP-100-1 | 100 | 1 |
| LP-100-3 | 100 | 3 |
| LP-100-0.5 | 100 | 0.5 |

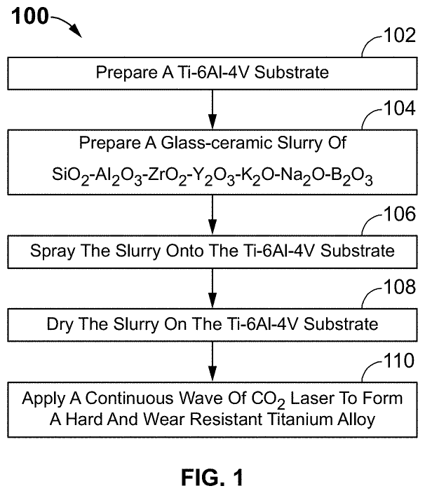

Referring to FIG. 1, a flowchart 100 of a preparation method of hard and wear resistant titanium alloy is disclosed, according to an embodiment of the present invention. At step 102, a Ti-6Al-4V substrate is prepared. Initially, one or more Ti-6Al-4V plates with dimensions of 30×10×1 mm are grounded with silicon carbide papers of 400-2000 grit and polished with a 5m diamond paste. The polished mixture is then treated by sandblast method followed by ultrasonic cleaning and drying to form the Ti-6Al-4V substrate.

At step 104, a glass-ceramic slurry of SiO₂—Al₂O₃—ZrO₂—Y₂O₃—K₂O—Na₂O—B₂O₃ is prepared. Raw glass materials including silicon dioxide (SiO₂), yttrium (III) oxide (Y₂O₃), potassium carbonate (K₂CO₃), sodium carbonate (Na₂CO₃), zirconium dioxide (ZrO₂), boric acid (H₃BO₃), and aluminum oxide (Al₂O₃) are mixed. Thereafter, at least one of ethanol or water is mixed with the mixture in 2:1 ratio. Further, 1.5 g of 1% CMC adhesive is added to the mixture and grounded to form the glass-ceramic slurry. At step 106, the slurry is sprayed onto the Ti-6Al-4V substrate. At step 108, the slurry on the Ti-6Al-4V substrate is dried. At step 110, a continuous wave of CO₂ laser is applied on the slurry for cladding to form the hard and wear resistant titanium alloy. The CO₂laser comprises an operating wavelength of 10.6 nm, a laser beam diameter of 2 mm, and an output power of 70-100 W with scanning speed 1-3 mm/s.

The composite comprises silicon dioxide (SiO₂) of 51 mole %, yttrium (III) oxide (Y₂O₃) of 2.4 mole %, potassium carbonate (K₂CO₃) of 4 mole %, sodium carbonate (Na₂CO₃) of 6 mole %, zirconium dioxide (ZrO₂) of 5.6 mole %, boric acid (H₃BO₃) of 20 mole %, and Aluminum oxide (Al₂O₃) of 11 mole %. The Ti-6Al-4V substrate comprises aluminum (Al) of 5.83 wt %, vanadium (V) is 3.86 wt %, copper (Cu) of 0.15 wt %, molybdenum (Mo) of 0.43 wt %, stannum (Sn) of 0.35 wt %, niobium (Nb) of 0.35 wt %, palladium (Pd) of 0.15 wt %, iron (Fe) of 0.15 wt %, and titanium (Ti) of 90 wt %.

### EXAMPLES

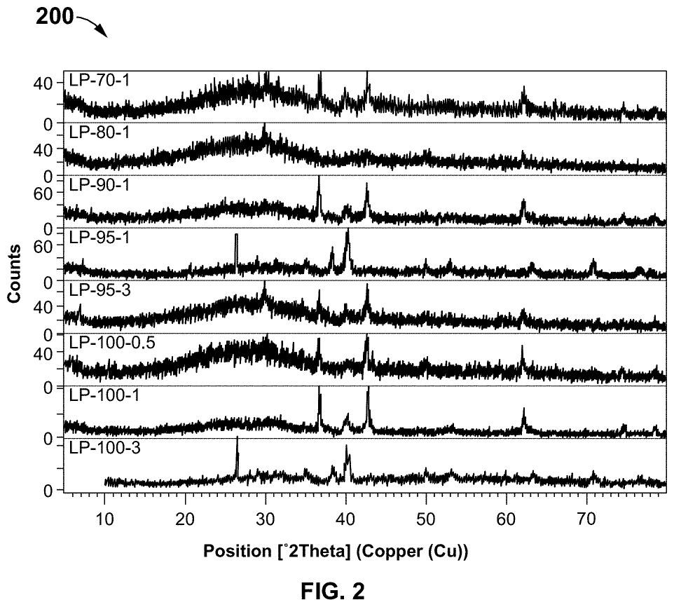

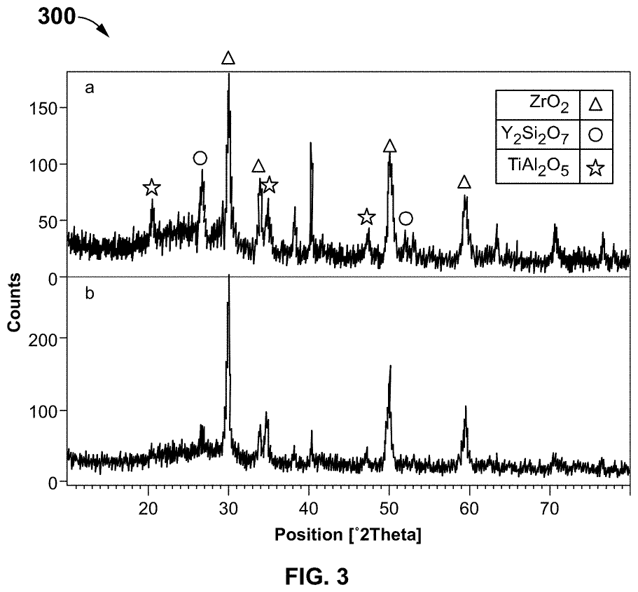

The following examples demonstrate but do not limit the present invention. An X-ray diffraction (XRD) device is used for the structural and the phase analysis of laser treated samples is shown FIG. 2. FIG. 2 exemplarily illustrates a graph 200 of X-ray diffraction (XRD) patterns of laser treated samples, according to an embodiment of the present invention. The sample LP-80-1 has uniform amorphous phase. Therefore, all experiments have been carried on this sample. Then, the sample was heat-treated for about 30 minutes at a temperature of 850° C. to obtaining glass-ceramic features, like good toughness, hardness and stable phases and also making high bonding strength between the coating and Ti-6Al-4V substrate. The XRD of laser coated samples are shown in FIG. 1. The coating phases were identified by software such as High Score Plus3.0 software. As shown in FIG. 3, cubic zirconia (JCPDS 07-0337) or tetragonal (JCPDS 50-1089) (ZrO₂) was identified as a dominant phase.

FIG. 3 exemplarily illustrates a graph 300 of X-ray diffraction analysis spectra for laser treated samples (a) before and (b) after heat treatment, according to an embodiment of the present invention. “a” represents X-ray diffraction analysis for laser treated samples before heat treatment and “b” represents X-ray diffraction analysis for laser treated samples after heat treatment. ZrO₂ have been doped as the nucleating agents in the SiO₂—Al₂O₃—ZrO₂—Y₂O₃—K₂O—Na₂O—B₂O₃. As a result, zirconia ZrO₂ is seemed to be the first phase to be crystallized in the glass. The other identified phase is the Y₂Si₂O₇ phase (JCPDS 1994-1994). It can be concluded that the above phase YS is crystallized preferably in the joint intersection with the air.

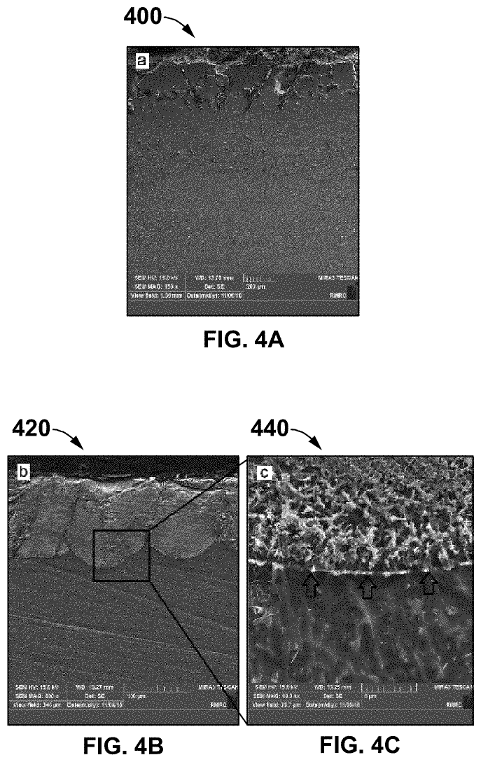

Referring to FIG. 4A-FIG. 4C, scanning electron microscope (SEM) cross-section of laser coated sample is shown. FIG. 4A illustrates an image 400 of SEM cross-section of laser coated sample before heat treatment. FIG. 4B illustrates an image 420 of SEM cross-section of laser coated sample after heat treatment at 850° C. FIG. 4C illustrates an image 440 of SEM cross-section of laser coated samples after heat treatment at 850° C. for 20 minutes at different magnification.

Referring to FIG. 4A, the coating is completely blended with the substrate and thus, has some of the properties of metals such as ductility, toughness, etc., i.e. coating is integrated with the substrate and the coating is almost a part of the substrate. However, the coating and substrate are separated in FIG. 4B. FIG. 4C shows a low magnification image. The absence of decohesion cracks and pores along the coating/substrate boundary (arrowed) indicates good coating consolidation.

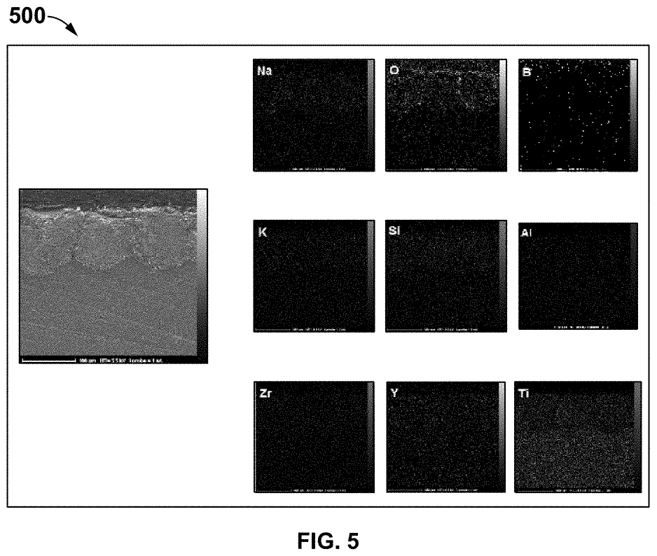

In order to understand whether the glass compounds were distributed uniformly within the coating, a MAP analysis was conducted on coating and substrate. FIG. 5 shows images 500 of MAP analysis of the cross-sectional area of the heat-treated sample and the distribution of chemical composition on the deposited surface. It is obvious that the constituents are evenly distributed within the coating, indicating the correct implementation of the coating.

The coated and uncoated samples were prepared for abrasion testing by washing under a tap and distilled water, and subsequent drying with pressurized air. The prepared samples were kept upright in closed plastic boxes before the abrasion experiment in order to ensure uniform conditioning of the surface and to protect them from dust. The abrasion test was carried out with a pin on disk method by wheel abrader. Digital images of the thus-abraded samples were taken with an optical microscope in reflectance mode, equipped with a simple camera and calculated as weight loss. Weights of the dry samples were measured with precision scales. During abrasive wear testing, the load was kept as 6 kg. Weight loss of the uncoated and coated samples was measured after each 300 meters travel of the wheel. The weight losses of uncoated and coated samples are given in Table 4. According to the results, the amount of weight loss in the non-coated sample is about 21 times more than the coated sample.

TABLE 4
The influence of load on wear behavior

| | | Weight after | |
|---|---|---|---|
| | Initial weight | abrasion test | Weight loss |
| Samples | (g) | (g) | (g) |
| Uncoated Ti-6Ai-4V | 5.0458 | 5.0163 | 0.0295 |
| Coated Ti-6Ai-4V | 6.4842 | 6.4828 | 0.0014 |

The present invention utilizes laser cladding to deposit glass precursors with the composition SiO₂—Al₂O₃—ZrO₂—Y₂O₃—K₂O—Na₂O—B₂O₃ on titanium alloy Ti-6Al-4V substrate. The microstructure of the coating layers was characterized by X-ray Diffraction (XRD), Scanning Electron Microscopy (SEM) equipped with EDS and, and also the mechanical properties of the coated samples were investigated by, Vickers microhardness and tribological experiments. It is demonstrated that the coating was adhered firmly to the Ti-6Al-4V substrates. The amount of weight loss after wear sliding test in the coated sample was about 21 times less than uncoated sample. Moreover, The Vickers microhardness of laser coated sample before and heat treatment were 1914.08 and 1329.6, respectively.

The present invention provides a hard and wear resistant coating for titanium alloys by laser processing for industrial application. The coated titanium alloy of the present invention could be used in the aviation and maritime application. The need of industrial furnace operated using fossil fuels is replaced using laser technologies, which reduces the amount of pollutants entered in the atmosphere to almost zero and resolves the drawback of heat generation in the environment. The proposed technique of the present invention is very simple and the coating process could be performed by a laser at any condition and location, without requiring any specific technical knowledge.

The presence of TiO₂ layer on the metal substrate surface eliminates the need to use a bond coat or slipware, leading to significantly higher adhesive strength and avoiding the manufacturing and coating costs of the middle layer. The brittle nature of glasses usually results in crack and breakage of glasses after a short period of time, due to the abrasion. However, the glass presented in the present invention is very hard such that no cracking or weight loss is observed by conducting the abrasion test on the glass. In recent years, glass-ceramic coatings have become very promising materials for the protection against titanium alloy oxidation at elevated temperatures due to excellent chemical inertness, self-healing ability, and high-temperature stability. Moreover, glass-ceramics is an appropriate candidate for sealing and coating applications where compatible thermal expansions are essential.

If a high level of hardness is required and the environment is not corrosive (hard acidic environments such as acidic solution H₂SO₄ (11 molars, boiling)), there is no need for heat treatment of coating and it is possible to use the glass coating. In other words, no heat treatment is required for the laser-treated samples inside the furnace. In the case of a corrosive environment, the coated samples should be heat-treated at a temperature of 850° C. for 20 to 40 minutes. The hardness of titanium Ti-6Al-4V metal in the microhardness test is about 300-400, although this value reaches 1500-2000 after applying the coating process of the present invention. The coating of the present invention could be used in environments requiring the mentioned alloy and high abrasion resistance, in order to significantly reduce maintenance costs. By applying the coating, the titanium Ti-6Al-4V alloy could be used in the aviation and maritime industries, instead of nickel and cobalt-based superalloys, to significantly reduce costs.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method.

Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein. While the above is a complete description of the preferred embodiments of the invention, various alternatives, modifications, and equivalents may be used. Therefore, the above description and the examples should not be taken as limiting the scope of the invention, which is defined by the appended claims.

1. A method of preparing hard and wear resistant titanium alloy, comprising the steps of:
preparing a Ti-6Al-4V substrate;
preparing a glass-ceramic slurry of SiO₂—Al₂O₃—ZrO₂—Y₂O₃—K₂O—Na₂O—B₂O₃;
spraying the slurry onto the Ti-6Al-4V substrate;
drying the slurry on the Ti-6Al-4V substrate, and
applying a continuous wave of CO₂ laser to form the titanium alloy.

2. The method of claim 1, wherein the step of preparing Ti-6Al-4V substrate includes:
a) providing one or more Ti-6Al-4V plates with dimensions of 30×10×1 mm;
b) grounding the plates with silicon carbide papers of 400-2000 grit;
c) polishing a mixture obtained at step (b) with 5m diamond paste;
d) treating a mixture obtained at step (c) using a sandblast method, and
e) cleaning and drying a mixture obtained at step (d) to form the Ti-6Al-4V substrate.

3. The method of claim 1, wherein the step of preparing the glass-ceramic slurry of SiO₂—Al₂O₃—ZrO₂—Y₂O₃—K₂O—Na₂O—B₂O₃ includes:
a) mixing raw glass materials including silicon dioxide (SiO₂), yttrium (III) oxide (Y₂O₃), potassium carbonate (K₂CO₃), sodium carbonate (Na₂CO₃), zirconium dioxide (ZrO₂), boric acid (H₃BO₃), and aluminum oxide (Al₂O₃);
b) mixing at least one of ethanol or water with the mixture obtained at step (a) in 2:1 ratio, and
c) adding 1.5 g of 1% CMC adhesive to a mixture obtained at step (b) and grounded to form the glass-ceramic slurry.

4. The method of claim 1, wherein the CO₂ laser comprises an operating wavelength of 10.6 nm, a laser beam diameter of 2 mm, and an output power of 70-100 W with scanning speed 1-3 mm/s.

5. The method of claim 1, wherein the glass-ceramic slurry comprises silicon dioxide (SiO₂) of 51 mole %, yttrium (III) oxide (Y₂O₃) of 2.4 mole %, potassium carbonate (K₂CO₃) of 4 mole %, sodium carbonate (Na₂CO₃) of 6 mole %, zirconium dioxide (ZrO₂) of 5.6 mole %, boric acid (H₃BO₃) of 20 mole %, and aluminum oxide (Al₂O₃) of 11 mole %.

6. The method of claim 1, wherein the Ti-6Al-4V substrate comprises aluminum (Al) of 5.83 wt %, vanadium (V) is 3.86 wt %, copper (Cu) of 0.15 wt %, molybdenum (Mo) of 0.43 wt %, stannum (Sn) of 0.35 wt %, niobium (Nb) of 0.35 wt %, palladium (Pd) of 0.15 wt %, iron (Fe) of 0.15 wt %, and titanium (Ti) of 90 wt %.

7. A hard and wear resistant titanium alloy, comprising:
a Ti-6Al-4V substrate coated by a glass-ceramic composite of SiO₂—Al₂O₃—ZrO₂—Y₂O₃—K₂O—Na₂O—B₂O₃,
wherein the composite comprises silicon dioxide (SiO₂) of 51 mole %, yttrium (III) oxide (Y₂O₃) of 2.4 mole %, potassium carbonate (K₂CO₃) of 4 mole %, sodium carbonate (Na₂CO₃) of 6 mole %, zirconium dioxide (ZrO₂) of 5.6 mole %, boric acid (H₃BO₃) of 20 mole %, and aluminum oxide (Al₂O₃) of 11 mole %, and
wherein the substrate comprises aluminum (Al) of 5.83 wt %, vanadium (V) is 3.86 wt %, copper (Cu) of 0.15 wt %, molybdenum (Mo) of 0.43 wt %, stannum (Sn) of 0.35 wt %, niobium (Nb) of 0.35 wt %, palladium (Pd) of 0.15 wt %, iron (Fe) of 0.15 wt %, and titanium (Ti) of 90 wt %.

8. The titanium alloy of claim 1, wherein the glass-ceramic composite is coated to the Ti-6Al-4V substrate by laser cladding method.

9. The titanium alloy of claim 1, wherein the glass-ceramic composite is coated to the Ti-6Al-4V substrate by applying a continuous wave of CO₂ laser.

10. The titanium alloy of claim 9, wherein the CO₂ laser comprises an operating wavelength of 10.6 nm, a laser beam diameter of 2 mm, and an output power of 70-100 W with scanning speed 1-3 mm/s.
